(19) United States
(12) Patent Application Publication
(10) Pub. No.: US 2003/0028609 A1
(43) Pub. Date: Feb. 6, 2003

(54) Distributed system for computer interaction

(76) Inventor: Michael Cahill, New South Wales (AU)

Correspondence Address: STETINA BRUNDA GARRED & BRUCKER, 75 ENTERPRISE, SUITE 250, ALISO VIEJO, CA, 92656, US

(21) Appl. No.: 10/174,298

(22) Filed: Jun. 18, 2002

Related U.S. Application Data
(63) Continuation of application No. 09/474,468, filed on Dec. 29, 1999.

(30) Foreign Application Priority Data
Oct. 22, 1999 (AU) PQ3620
Sep. 1, 1999 (AU) PQ2565
Aug. 25, 1999 (AU) PQ2442
Aug. 17, 1999 (AU) PQ2259

(51) Int. Cl. G06F 15/16

(52) U.S. Cl. 709/208

(57) ABSTRACT

A distributed system for computer interaction; the system including

a device having computing means therein and

a remote computer located or locatable remotely from the device,

communication means whereby bi-directional communication is established between the device and the remote computer;

the device arranged to execute a client application;

the remote computer arranged to execute a control application.

The present invention relates to a distributed system for computer interaction and, more particularly, to such a system and components therefore, for example when operating in a client/server mode, which provides increased capability for the client whilst also providing control over the volume of client/server data interchange.

### BACKGROUND

The client/server model for interaction between computers or computer based systems is well established. A problem with such arrangements is that functions executed by the client which rely on delivery of data from the server can give rise to the transfer of unexpectedly large volumes of data over communication networks between the server and the client and over which there is no control once the function has been put in train. Given the highly distributed nature of many networks these days where it is not uncommon for the server to be located, literally, on the other side of the world from the client it follows that this characteristic of known systems can give rise to highly variable response times for the system as a whole and may, in some circumstances, and unpredictably so, lead to complete failure of the interaction between client and server.

A separate problem, although sometimes related to the data transfer problem referred to above, concerns a reduction in capability of the client when operating under a client/server environment as compared with the capability of the client when operating on its own.

While the above problems have been referenced within the context of a client/server model, such problems can be encountered wherever and whenever two or more distributed computing systems need to interact.

It is an object of the present invention to provide a system and components therefor which seek to address or ameliorate one or more of these perceived problems.

### BRIEF DESCRIPTION OF INVENTION

Accordingly, in accordance with one aspect of the invention there is provided a distributed system for computer interaction; said system including

a device having computing means therein and

a remote computer located or locatable remotely from said device,

said device arranged to execute a client application which makes reference to a client capability set definition library located on said device;

said remote computer arranged to execute a control application which makes reference to a corresponding capability set definition library located on said remote computer.

Preferably said system operates sequentially in the following steps:

(a) said client application on said device initiates communication with said control application on said remote computer for the purpose of establishing a communications session between said device and said remote computer;

(b) said client application and said control application agree on mutual use of said capability set definition library;

(c) said control application and said client application maintaining communication during said communication session whereby predetermined aspects of operation of said device are determined by said control application with reference to said capability set definition library.

In accordance with a further aspect of the invention there is provided a distributed client/server system for at least

a first device and

a first remote computer

said first device arranged to execute a client application which makes reference to an at least first client capability set driver;

said at least first remote computer arranged to execute a control application which makes reference to an at least first capability set definition library;

said system operating sequentially in the following steps:

(a) said client application on said device initiates communication with said control application on said remote computer for the purpose of establishing a communications session;

(b) said client application and said control application agree on a capability set definition library and a corresponding client capability see driver for use during said communication session;

(c) said control application and said client application maintaining communication during said communication session whereby predetermined aspects of operation of said device are determined by said control application with reference to said selected capability set definition library and said corresponding selected client capability set driver

Preferably said capability set definition library contains a set of definitions of predetermined, selected capabilities of said device.

Preferably said predetermined capabilities are primitive functions of the device.

Preferably said capabilities are selected in order to minimise traffic during said communications session. Preferably said communications session includes the communicating of update information pertinent to the status of individual ones of said capabilities invoked with the aid of said capability set definition library.

Preferably said communications session occurs over a network link.

In accordance with yet a further aspect of the present invention there is provided a distributed system for computer interaction; said system including

a device having computing means therein and

a remote computer located or locatable remotely from said device,

communication means whereby bi-directional communication is established between said device and said remote computer;

said device arranged to execute a client application;

said remote computer arranged to execute a control application.

Preferably said device makes reference to a client capability set definition library located on said device. Preferably said control application makes reference to said capability set definition library.

Preferably said capability set definition library resides on both said device and said remote computer. Preferably said system operates sequentially in the following steps:

(a) said client application on said device initiates communication with said control application on said remote computer for the purpose of establishing a communications session between said device and said remote computer;

(b) said client application and said control application agree on mutual use of said capability set definition library;

(c) said control application and said client application maintaining communication during said communication session whereby predetermined aspects of operation of said device are determined by said control application with reference to said capability set definition library.

Preferably said capability set definition library contains a set of definitions of predetermined, selected capabilities of said device.

Preferably said predetermined capabilities are primitive functions of the device.

Preferably said capabilities are selected in order to minimise traffic during said communication session. Preferably said communication session includes the communicating of update information pertinent to the status of individual ones of the capabilities invoked with the aid of said capability set definition library.

In accordance with yet a further aspect of the invention there is provided in a distributed system for computer interaction; said system including

a device having computing means therein and

a remote computer located or locatable remotely from said device,

said device arranged to execute a client application;

said remote computer arranged to execute a control application; a method of operating said system according to the following:

(a) making available a capability set definition library on both said device and said remote computer;

(b) said client application on said device initiates communication with said control application on said remote computer for the purpose of establishing a communications session between said device and said remote computer;

(c) said client application and said control application agree on mutual use of said capability set definition library;

(d) said control application and said client application maintaining communication during said communication session whereby predetermined aspects of operation of said device are determined by said control application with reference to said capability set definition library.

Preferably said remote computer builds a model of the state of said client application so as to interact with said device by interacting with said model.

Preferably said model is continuously updated so as to reflect current status of said client application on said device.

Preferably said device is arranged to execute said client application with reference to a client capability set definition library located on said device and said remote computer is arranged to execute said control application by making reference to a corresponding capability set definition library located on said remote computer.

Preferably said capability set definition library comprises a plurality of capability definitions, each of said definitions determined with reference to the desired functionality of said device.

Preferably each of said capability definitions comprises a primitive function of said device.

In an alternative preferred form each of said capability definitions comprises a combination of primitive functions of said device.

In accordance with yet a further aspect of the invention there is provided a distributed client/server system for at least

a first device and

a first remote computer;

communication means whereby bi-directional communication is established between said device and said remote computer;

said first device arranged to execute a client application which makes reference to an at least first client capability set driver;

said at least first remote computer arranged to execute a control application which makes reference to an at least first capability set definition library;

said system operating sequentially in the following steps:

(a) said client application on said device initiates communication with said control application on said remote computer for the purpose of establishing a communications session;

(b) said client application and said control application agree on a capability set definition library and a corresponding client capability set driver for use during said communication session;

(c) said control application and said client application maintaining communication during said communication session whereby predetermined aspects of operation of said device are determined by said control application with reference to said selected capability set definition library and said corresponding selected client capability set driver;

said system arranged to communicate codes over said communication means which make reference to capability definitions in said capability set definition library thereby to control the volume of traffic on said communication means.

### BRIEF DESCRIPTION OF DRAWINGS

Embodiments of the invention will now be described with reference to the accompanying drawings wherein:

FIG. 1 is a block diagram of a flexible, distributed system for computer interaction according to a first embodiment of the invention;

FIG. 2 is a diagram of an example client device and an example server remote computer implementing a specific graphical function interchange under the system of FIG. 1;

FIG. 3 is an exemplary block of program code for a control application running on the server remote computer of FIG. 1 which implements the graphical function interchange illustrated in FIG. 2;

FIG. 4 is a timing, step diagram showing the steps involved in a typical interchange between the client device and server remote computer of FIG. 1 to implement the example of FIG. 2;

FIGS. 5A-5K illustrate in block diagram form more detailed steps of the interaction and data transfer between the server remote computer and client device of FIG. 1 which give effect to the example of FIG. 2.

FIG. 6 is a block diagram of a flexible, distributed client/server system according to a second embodiment of the invention;

FIG. 7 is a block diagram of a multiple client/multiple application scenario possible with the embodiment of either FIG. 1 or FIG. 6;

FIG. 8 is a block diagram of a capability set definition library according to a further embodiment of the invention;

FIG. 9 is a block diagram of a capability set definition library according to yet a further preferred embodiment of the invention; and

FIG. 10 illustrates an exemplary implementation scenario of an embodiment of the present invention.

### DETAILED DESCRIPTION OF PREFERRED EMBODIMENTS

Preamble

With reference to the drawings, embodiments of a system 10, 110 incorporate a new way of thinking about how arbitrary devices or clients are incorporated into computer systems. This has led to the implementation of a system that allows, for example, an application on a distant or remote computer 13, 113 to create a graphical user interface (GUI) on a (remote) display 16, 116 device and to handle the interactions with a person using the device 11, 111 on which the display is located.

Distributed Systems

One of the most basic problems in the construction of large systems concerns communication networks. Systems that involve only a single computer are much easier to design and understand than systems that involve interactions between autonomous execution environments. An understanding of single computer design does not scale simply into an understanding of distributed system design.

When thinking about any computer system, there are some questions whose answers are often enlightening:

Where is the data and how is it represented?

Where is the application logic?

How does the data change over time?

How does the system interact with its external environment?

A system that has clear answers to these questions has a chance of working in a production environment. Unfortunately, few of the large systems built so far satisfy this condition. Instead:

Data is stored in databases, separate from the “application” and in a form that must be transformed when it crosses the boundary between the database and the rest of the system.

Pieces of application logic are scattered around the system, from database tables to application servers to clients.

Many parts of the system cause changes to the data.

User interactions are an afterthought or are grafted onto inappropriate interfaces.

### DESIRED ATTRIBUTES OF PREFERRED EMBODIMENTS

It is perceived as desirable to be able to create a mechanism that will allow interaction with arbitrary devices connected to a remote computer via a network using as little bandwidth as possible. In particular, it is desirable to be able to allow interaction between control applications on the remote computer and a client such as:

any desktop computer that can run a web browser;

handheld computers (Palm Computing™ devices, Windows CE™); and

mobile phones.

Desirably the interactions should work over low bandwidth connections. In particular, it is desirable to use the system over a 9600 baud modem line (the communication rate of current mobile phone networks).

Desirably, the mechanism should be “natural” for application programmers to use. They should not have to learn about the details of how the devices communicate with the system. They should be able to make use of the capabilities of external devices without losing the idea that they are building a direct model of an application. Details should not influence design.

So, to summarise, desirable attributes are:

to support a wide range of devices, connected via a network;

to use low bandwidth; and

to provide a simple, familiar programming environment for application developers.

Various embodiments of the present invention achieve one or more of these desired attributes, broadly speaking, by the adoption of an approach whereby both the remote computer (server) and client application agree to adopt a “capability set definition library”. The adoption of this library permits the communication between the computers of short codes which can trigger much higher level data manipulation and utilisation with reference to a specified member or members of the capability set definition library. The members of the capability set definition library can be chosen or formulated with a view to the volume of communication traffic comprising the codes which can be tolerated for any given application and the likely communications environment in which it is expected to operate. So, for example, a local intranet or network having a high band width and reliable communications system in place could be expected to tolerate a much higher volume of data comprising or relating to the codes than a system which may have to operate over low band width dial up modems or the like. The concept of a capability set definition library is defined more fully immediately below and by way of example provided by the various embodiments to be described in detail below.

Adoption of the concept of a common, agreed capability set definition library permits the remote computer or server application to influence the operation of the client application if not, in some circumstances, entirely control it. The server application is able to do this by, effectively, building a local model of the operation of the client application. Local operation on the model leads to equivalent operations taking effect on the client application.

Capability Set Definition

In order to create a capability set definition library it is first necessary to determine the desired or actual functionality of a device and then define operations which can be invoked on the device or by the device to give effect to that desired functionality. Each operation is, effectively, a “capability” of that device and can form a member of the capability set definition library for that device.

In particular instances the operations will be very basic or primitive capabilities and will be a subset of the total functionality of the device. So, for example, for a display device, one whose primary function is to display, the primitives will be display primitives which, for example, can be defined at the level of a character, the level of a geometrical shape or, alternatively, can be defined mathematically as vectors. These primitives, when invoked and caused to display according to their particular capability will drive the total appearance of the display device.

In alternative embodiments the operations can comprise combinations of primitives which build to form a higher level or more sophisticated or more complex capability.

These operations thus identified to give effect to the desired functionality are placed into a library so as to form the capability set definition library.

The preferred criteria for selecting members of a capability set definition library are as follows:

1. The innate capability of the client;

2. What the client wants to do or is expected to do with that capability; and

3. The bandwidth of the communications channel and/or other characteristics of the communications channel such as, for example, latency.

Taking into account the criteria the members of a capability set definition library can then be formulated so as to ensure acceptable performance by the client application.

First Preferred Embodiment

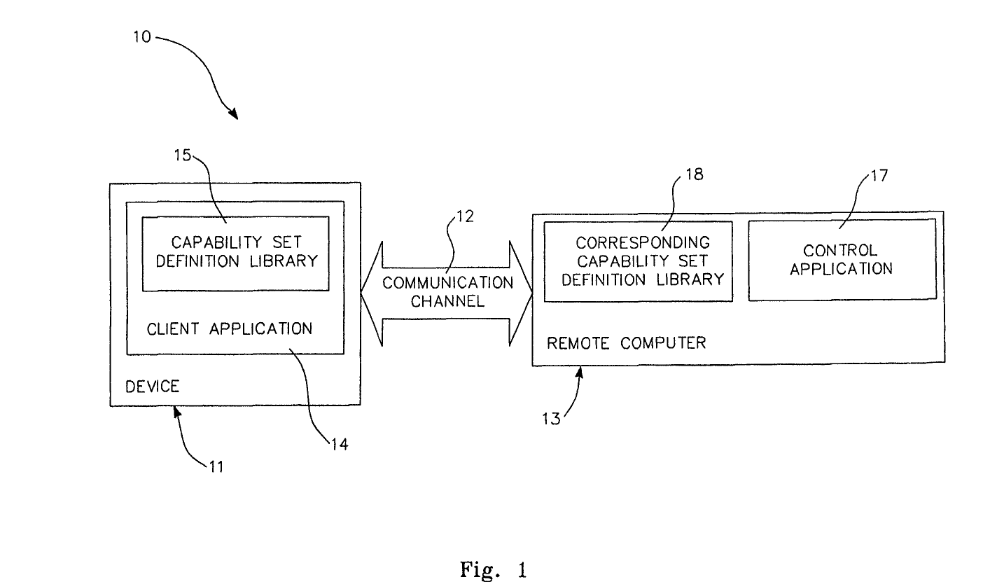

With reference to FIG. 1 there is illustrated in block diagram form a flexible, distributed system for computer interaction 10 according to a first preferred embodiment of the invention.

In this case the system 10 comprises a device 11 which can communicate via communication channel 12 with a remote computer 13. It is to be understood that both device 11 and remote computer 13 include computing means and memory within them (not shown) which permit the execution of software code. Such code is most usually executed in the environment of an operating system operating on a computing hardware platform. Example current operating systems include Windows™ 95/98/CE/NT, Unix, Linux. Example current hardware platforms include the Intel series of microprocessors (e.g. Pentium) and the Motorola series of microprocessors. The system of this embodiment is not limited to operation on any particular hardware platform nor under any particular operating system. Indeed it is expected that, most usually, the hardware platform of the remote computer 13 will differ from the hardware platform of the device 11. Similarly it is expected that, most usually, the operating system of remote computer 13 will differ from the operating system of device 11. All that is required for operation of the system is a compatible communications protocol (an example of which will be given in greater detail below) to permit the transmission of data between remote computer 13 and device 11.

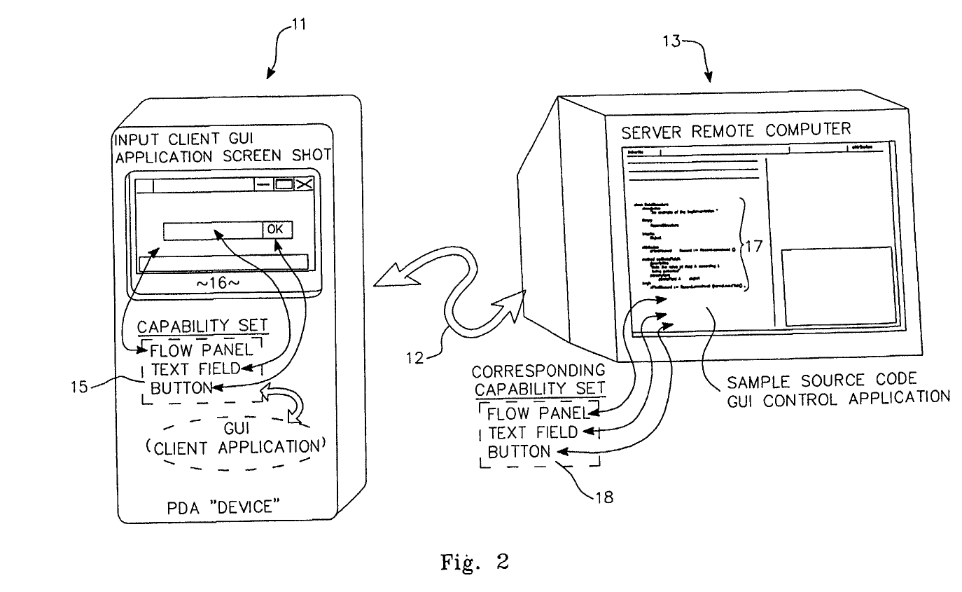

Device 11 is adapted to run or execute via its computing means a client application 14, the client application being able to reference a capability set definition library 15 also loaded or stored on device 11. Whilst device 11 can be almost any kind of device having a computing capability such as, currently but by no means exclusively, a personal computer, a personal digital assistant (PDA), a “palmtop” or hand held (e.g. Windows CE) computer or a controller device operating or assisting the operation of devices such as mobile phones, lifts, industrial controllers (e.g. PLC's) and the like the device 11 will be exemplified with reference to FIG. 2 as a personal digital assistant (PDA) having a display screen 16 which can communicate with a user via a graphical user interface (GUI).

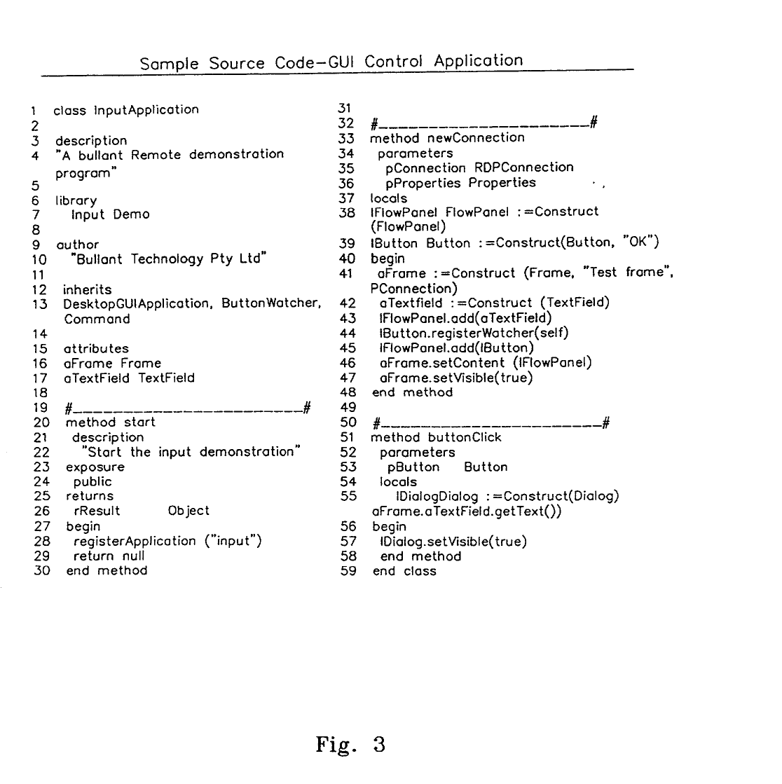

In the specific example of FIGS. 2 and 3 the PDA device 11 is loaded with a GUI client application 14 which is capable of drawing specific objects on screen 16 so as to provide a graphical user interface with a user of PDA device 11. The objects which can form part or all of the graphical user interface are defined in the capability set definition library 15, in this instance being “FLOW PANEL”, “TEXT FIELD” and “BUTTON”.

The remote computer 13 is adapted to run a control application 17, in this case a “GUI control application”, the source code for which is listed in FIG. 3. The source code includes commands which rely on definitions of objects to be found in capability set definition library 18 which, in this example, correspond directly with the object definitions to be found in capability set definition library 15 on PDA device 11. That is, definitions are to be found in the library for “FLOW PANEL”, “TEXT FIELD” and “BUTTON” and giving rise to the same graphical constructs as displayed in FIG. 2 on screen 16.

Lines 16, 17 and 38, 39 define the objects which form the model 20 used by the control application 17.

In this instance, and with reference to earlier discussions in this specification as to the definition of the meaning of “capability set” and “capability set definition library” used in this specification, it is the case in this example that these three library members, FLOW PANEL, TEXT FIELD and BUTTON are each built from a combination of primitives.

These library members are built from selected primitive functions of PDA device 11, specifically

(a) pixel colour control primitive

(b) pointer device tracking primitive

(c) text/character recognition/input primitive.

FLOW PANEL determines screen layout and relies on (a). TEXT FIELD relies on (a) to present an appearance recognisable to a user as a text field. It relies on (b) for selection of text. It relies on (c) for text character input.

BUTTON relies on (a) to present an appearance which the user recognises as a button. It relies on (b) to recognise when the button has been clicked.

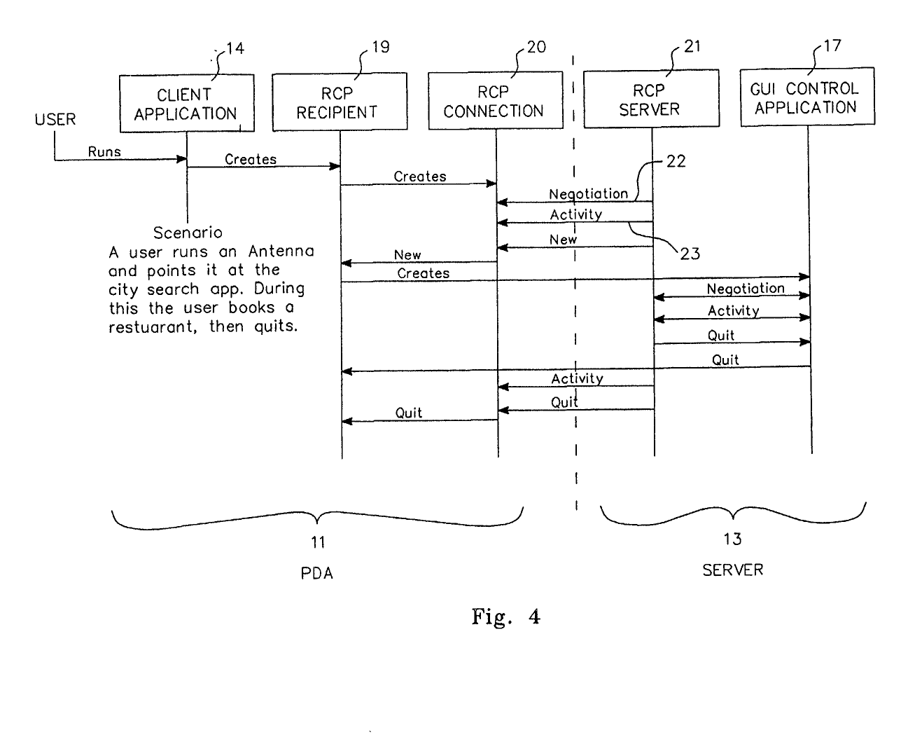

With reference to FIG. 4 initiation and maintenance of a communication session between device 11 and remote computer 13 over communication channel 12 is illustrated diagrammatically and indicates that a user (not shown) invokes client application 14 which, in turn, creates a remote control protocol (RCP) client 19 which then establishes an RCP connection 20 with an RCP server program 21 running on remote computer 13 which, in turn, communicates with, in this instance, GUI control application 17. It will be observed that a negotiation phase 22 initiates communication and establish an agreed capability set definition library which both the client application and the control application will reference. Having established this agreement the communication moves to an activity phase 23 whereby predetermined aspects of operation of device 11 are determined by control application 17 with reference to the capability set definition library, which is to say the corresponding capability set definition library 18 for the control application 17 and the capability set definition library 15 for the client application 14.

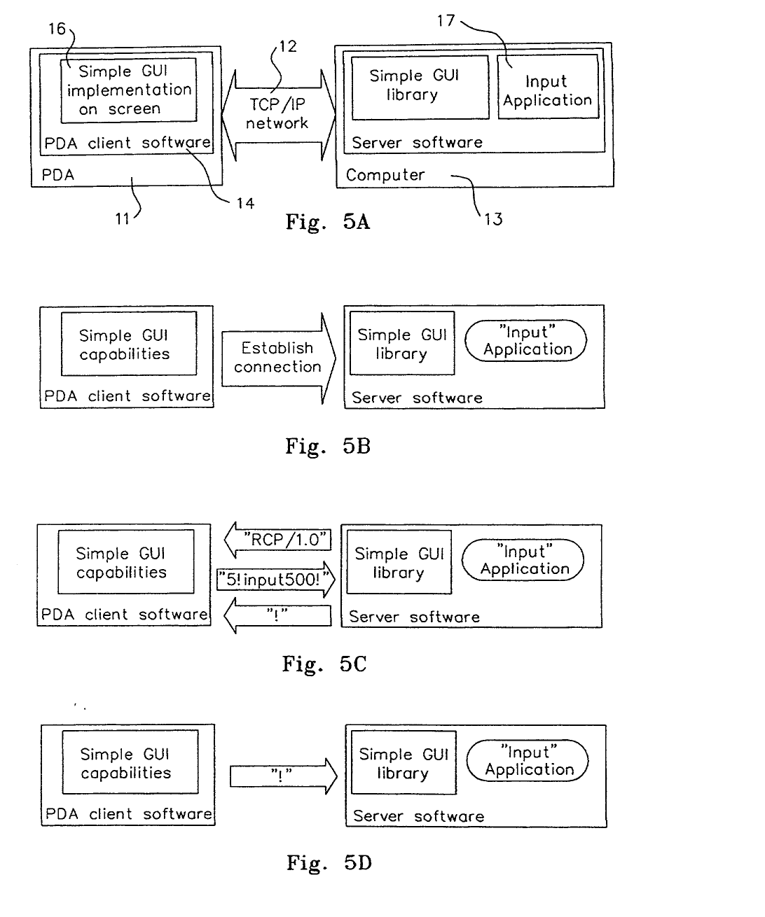

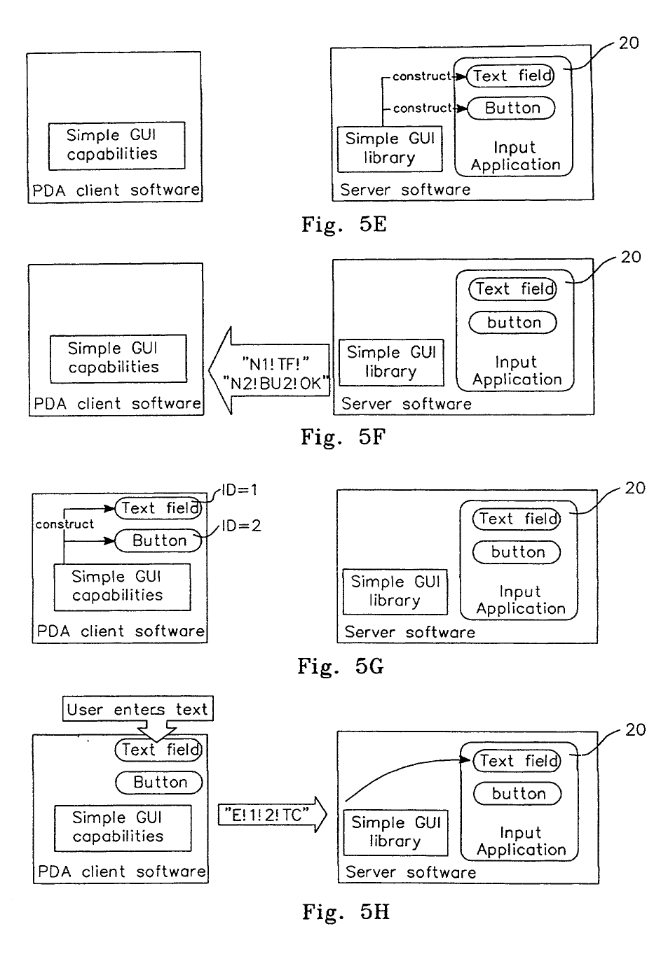

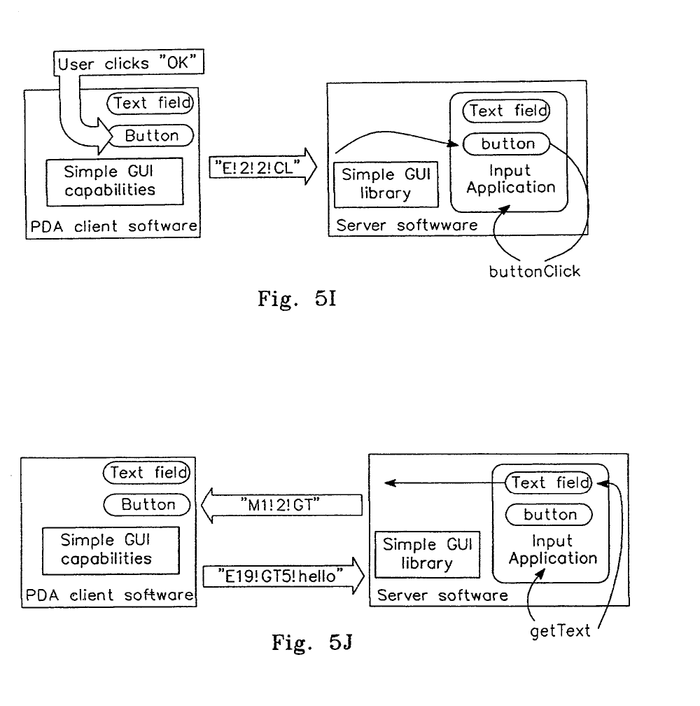

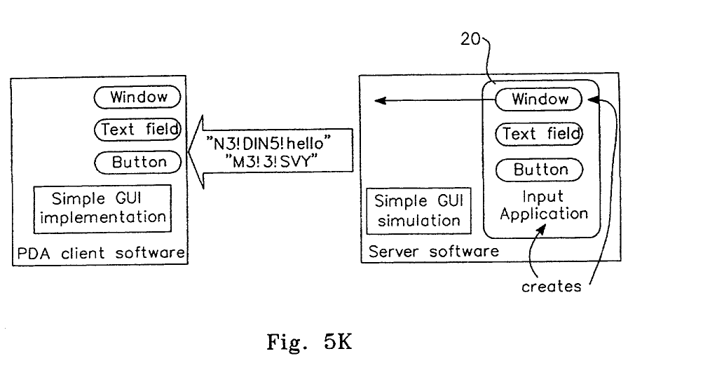

As will be described in more detail below with reference to FIG. 5 this arrangement permits a user to invoke the FLOW PANEL, TEXT FIELD and BUTTON appearing on screen 16 of the user's PDA device 11 and to have a text message which the user subsequently enters in the TEXT FIELD and a click of the BUTTON to be recognised by control application 17. In practice far more complex interactions will occur.

With reference to FIGS. 5A through to FIG. 5K a more detailed description of the interaction between PDA device 11 and remote computer 13 will be given and, in particular, describing in detail the character strings under a particular preferred remote control protocol (RCP) on the communication channel 12:

A PDA device 11, with a set of “simple GUI” capabilities (buttons, text fields, menus) and a simple application called “input” that wants to display a text field and a button to get input from a user (not shown) of the PDA device 11.

Note that this example is slightly contrived for simplicity. In particular, issues about screen layout are avoided here. In this instance, the communication channel 12 comprises a TCP/IP network.

The components of this scenario are outlined in FIG. 5A. Communication over the network follows the following sequential steps:

FIG. 5B Outlines Steps 1-2:

Step 1: The client application 14 running on the PDA 11 establishes a connection to the remote computer 13 running the control application 17 called “input”.

Step 2: The server software 24 accepts the incoming connection.

FIG. 5C Outlines Steps 3-8:

Step 3: The server sends “RCP/1.0” to identify that it is using the RCP protocol, version 1.0

Step 4: The client receives the protocol version and verifies that it is as expected

Step 5: The client sends the application name and capability set version. In this case, that is encoded: “5!input500!” The capability set library, in this instance, comprises three members namely FLOW PANEL, TEXT FIELD, and BUTTON.

Step 6: The server receives the message from the client

Step 7: The server checks the capability set version (500) in this case to make sure the requested application can make use of that capability set. In this case, the check succeeds and the server sends “!” (representing zero) to indicate that the negotiation has succeeded. If initial negotiation indicates a partial overlap in capabilities of the proposed capability sets then a new capability set definition library would be defined comprising either a super set or a sub set of the first proposed libraries so as to ensure that an exact match of capabilities is achieved for both the server and the client.

Step 8: The client receives the confirmation message from the server

FIG. 5D Outlines Steps 9-10:

Step 9: In this case, there are no application parameters, so the client sends “!” (representing zero) to inform the server of the number of parameters, and the client becomes “active”.

Step 10: The server receives the message and also becomes “active”.

FIGS. 5E and 5F Outline Step 11:

Step 11: The application now takes control of the connection. The first thing this application does is create a model 20 of the user interface which the application is programmed to present on PDA 11 consisting of a text field object and a button object from the simple GUI library of classes. This causes the following two commands to be sent from the server:

“N1!TF!”—creates a text field on the PDA 11 corresponding to the text field object in the model 20 from the capability set with object identity “1”.

“N2!BU2!OK”—creates a button on the PDA 11 corresponding to the text field object in the model 20 with identity “2” containing the string “OK”

FIG. 5G Outlines Step 12:

Step 12: The client receives these two commands and creates the text field and button objects on the client as instructed.

FIG. 5H Outlines Steps 13-14:

Step 13: The user can see the objects on the screen and interact with them. When the user enters something into the text field, the client generates the following event: “E1!2!TC”

Step 14: The server receives this event and the text field object created by the application is notified that its text has changed (i.e. that the client has a new value)

FIG. 5I Outlines Steps 15-16:

Step 15. The user finishes entering the text “hello” into the text field and then clicks the button. This generates the following event sent from the client to the server: “E2!2!CL” informing the server that the client's button object has been clicked.

Step 16: The server receives this event and the button object created by the application is notified that it was clicked.

FIG. 5J Outlines Steps 17-20:

Step 17: The application responds to this notification by asking the text field what value it holds.

Step 18: The text field knows that the contents held on the server are not up to date because of the earlier “TC” event, (steps 13 and 14) so it requests the text from the client with the following “get text” command:

“M1!2!GT”

Step 19: The client receives this command, and the text field on the client generates the following event:

“E1!9!GT5!hello”

Step 20: The server receives and decodes this event, and the application is informed of the result.

Note that at this point, the user has entered data into a remote application 17 running on remote computer 13. There has been a total of 30 bytes sent from the server remote computer 13 to the client device 11 and 40 bytes sent from the client device 11 to the server remote computer 13.

FIG. 5K Outlines Step 21:

Step 21: The remote application 17 changes the model 20 by creating a new window object. This change is communicated to the client application by sending the event “N3!DIN5!hello” “M3!3!SVY” with the end result that a new window with the title “hello” is displayed on the GUI interface of the PDA client.

It will be observed that this last step illustrates the active ability of the server application to influence the client application and to do so in a manner which requires only relatively short codes to trigger what can be high level data manipulation or other “high level” activity on or by the client.

In light of the above more detailed account, the example application source code of FIG. 3 will also be described in greater detail corresponding to the usage scenario described above with reference to FIGS. 5A-5J.

The source code of GUI control application 17 contains everything that an application programmer would need to know to make use of the system 10. All of the details about the establishment of the communication session and the messages that are passed back and forth between the device and the computer are hidden from applications. With reference to FIG. 3:

Starting the Application

The application is started by calling the method named “start” (line 22). This method registers the application with the name “input” so that a client can later interact with it. This must be done on the computer before step 1 in the usage scenario.

Connection Establishment

When a client establishes a connection, it is accepted by the server/library code, and after negotiation the application is activated. This results in the server/library code invoking the “newConnection” method (line 35). This corresponds to step 11 in the usage scenario.

This application creates four objects, a frame, a flow panel, a text field and a button (lines 41-44). The application also registers itself with the button so it can be notified when the button is clicked (line 48). These are then displayed on the newly established connection (line 51). This results in four “new” commands being sent to the client.

Button Click

When the user clicks the button (step 15), the client sends an event to the server, which then passes it to the button. So far, this is invisible to the application. The button then notifies the application (step 16) by calling the “buttonClick” method (line 55). This application then prints out a message on the computer to show that it has been informed that the button was clicked.

Having now described a simplified example of interaction the reader is referred to Annexure A which is a specification for the remote control protocol (RCP) and to Annexure B which is a specification for a capability set suitable for the GUI example previously given. Both of Annexures A and B form part of this specification.

Implementation can be in any suitable programming language such as, for example, C++.

Second Preferred Embodiment

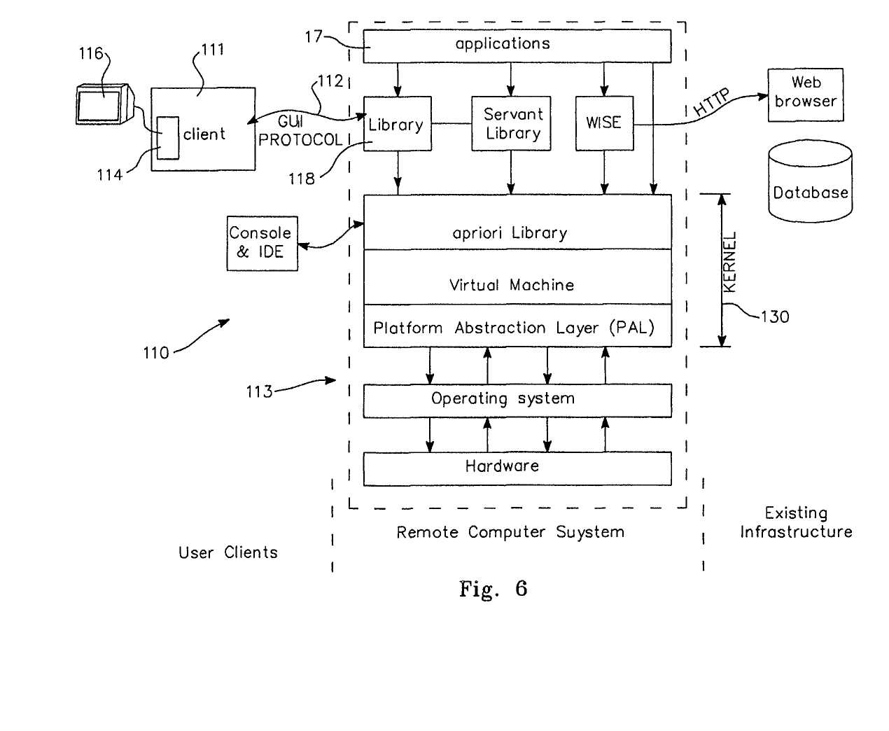

With reference to FIG. 6 there is shown an implementation of a flexible, distributed system for computer interaction according to a second embodiment of the invention and, in particular, showing more detail of an implementation on a remote computer. In this embodiment like components are numbered as for the first embodiment, except that they are prefixed with the numeral 1 to provide a “100” series of numbers. So, for example, remote computer 13 of the first embodiment becomes remote computer 113 of the second embodiment.

With reference to FIG. 6 there is illustrated in block diagram form a remote computer 113 connected via communications channel 112 to a client device 111.

Within remote computer 113 a capability set definition library 118 is in communication with a plurality of applications including a particular control application 117. The applications run under and with reference to kernel 130 of an operation system.

The relevant parts of a high level architecture of the environment in which applications for system 110 are written is as follows:

the capability set definition library 118, which is a set of classes that allows control applications 117 to display graphical user interfaces, and includes a server, which sends commands to the client device 111 describing layout of GUI elements in windows and receives and processes events from the client device 111.

The client application 114, which is a program that runs on device 111 with a display 116 and presents a user interface. It performs commands as instructed by the server and responds to the user's interactions by sending events to the server. The client application should be

simple and fast to download and install;

can be installed as a web browser plug-in for easy access to Kernel services; and

available across a range of platforms, with implementations for Windows, UNIX, MacOS, Palm OS, phones, etc.

Ideally this design has the following characteristics;

a familiar and simple programming model;

a simple layout mechanism, easily modeled in a GUI builder application;

lightweight client-server protocol (usable on 9600 baud serial line);

applicable to a wide range of devices (display or otherwise);

integrates handheld devices into business applications;

has many connections to a server over a modest bandwidth pipe;

provides a better user experience for Internet services;

has built in, transparent, standards-compliant security (based on SSL/TLS, X.509 certificates);

supports coordination of services to provide a distributed business transaction (e.g., Amazon writes code to choose books then links in Fedex for shipping and Visa for payment);

is an extensible model can take advantage of higher bandwidth if available (plug-ins for streaming audio/video, canvas support, etc.); and

has a desktop client that supports web content.

Device Capabilities

The system 110 is designed by concentrating on device capabilities as a central idea. Each device that an application may want to interact with has certain capabilities. It might be able to display a particular set of GUI elements such as buttons and text fields, or it may have a very limited display such as that found on a mobile phone.

To integrate diverse capabilities into a single programming model, the idea is to represent the capabilities of a device in an abstract model on the server. This involves creating a “class” for each of the capabilities a client might have. In the case of a desktop client, the capabilities include:

the ability to create windows;

the ability to place GUI elements (buttons, text fields, etc.) inside windows; and

the ability to display web pages.

The preferred capabilities set, comprising a GUI library thus includes classes corresponding to windows, buttons, text fields, and web viewers. Some devices may also have additional capabilities such as handlers for specific types of data, unusual input devices like cameras and microphones, and so on. Each of these can be modeled on the server by a class.

To make use of a device in this model, its primitive operations must be abstracted into a capability set. The same device may be abstracted in different ways. For example, a device with a bitmapped display can be abstracted either as a primitive such as a simple frame buffer that allows applications to set the color of each pixel, or it can be abstracted in terms of higher level GUI constructs composed of multiple primitives such as buttons, text fields and tree controls. The level of abstraction will determine the bandwidth requirements and the application interface.

A capability set is implemented by a set of classes (called the capability set model), and a set of client classes (called the client capability set). A device may implement more than one capability set, and an application may be written to make use of more than one capability set. To establish an active connection, the client and server must agree on which capability set to use for the remainder of the connection. Reaching this agreement is the purpose of negotiation.

The Protocol

A typical session is started as follows:

a client connects to the server and requests a particular application

the client and server negotiate about the capabilities to be used for this session

the client and server agree on a versioned set of classes, including a basic capability set (e.g. Desktop PC, Palm device, robot)

Once client and server agree on the classes representing the basic capability set, the operations are simple:

construct an object of a particular class

send a message to an object

forget about an object (delete)

quit (close this connection)

“browse” to another application and/or another server

check whether a particular extension supported (e.g., can the client handle a particular kind of data, or is a particular input device available, etc.)

The “objects” constructed on the client are very different from the objects being manipulated by server applications. On the client side the objects have direct control of the corresponding capability of the underlying client device. On the server side, they are only lightweight models.

All messages are class-specific (i.e., not specified by the basic protocol), so the implementation of each server class and the client class must match for the system to work. This can be achieved for example by requiring that all interfaces including extended capability classes are versioned, so that the set of classes that the client and server agree on match.

Collecting Multiple Applications into a Single User Interface

A device 111 with the client application 114 has an extra capability, the ability to make further connections to other servers. That is, a recursive capability which can be supported in exactly the same way as “ordinary” capabilities described thus far.

This particular capability is interesting, however, because it provides further new ways to use the client program:

one application can cause the client to make a sub-connection to another application

e.g. of use: bookshop implements book choosing, then delegates to Fedex for shipping and Visa for payment

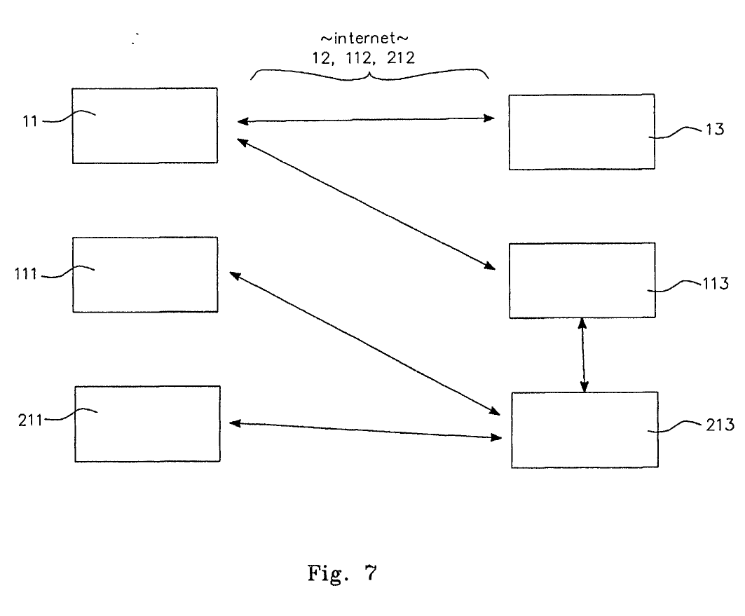

With reference to FIG. 7 possibilities resulting from invoking of multiple connections, for example over the internet, are illustrated diagrammatically including the recursive scenario referred to above. The end result is a powerful system which, when tuned appropriately, can provide rapid response times as perceived by a user operating the devices, 11, 111, 211 notwithstanding that a significant level of overhead is initiated in the process on remote computers 13, 113, 213.

Third Preferred Embodiment

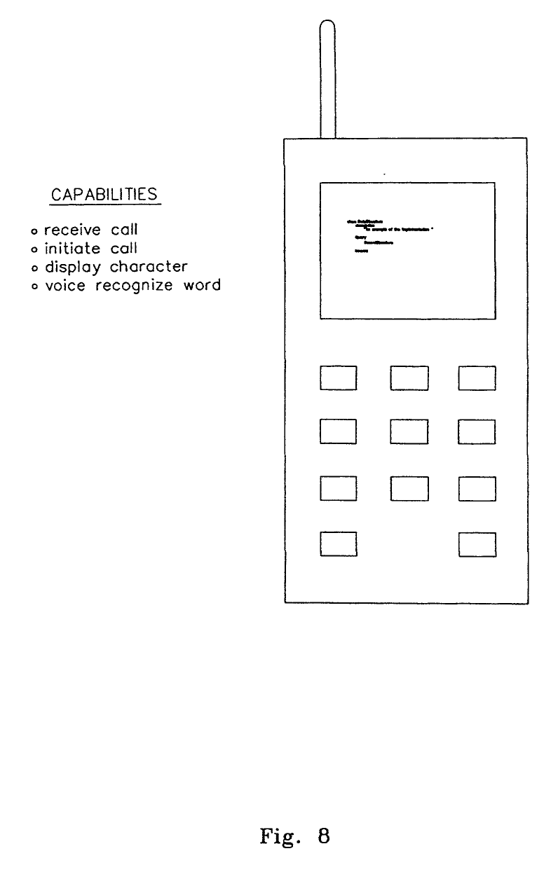

With reference to FIG. 8 an example is given where the client device is a mobile telephone 21 and the capabilities (or individual functions) which work together to define the total functionality of the mobile phone can include:

1. Receive call

2. Initiate call

3. Display character

4. Voice recognise word

These defined capabilities can be thought of as primitives, each of which defines only a small portion of the total functionality of the mobile phone device but which, when collected together, provide, in totality, useful capabilities grouped into the device commonly known as a mobile telephone.

In this instance it is desirable to select the capabilities with a view to minimising the amount of update information that will need to be passed between the client device and remote computer having the control application on it.

Typically the aim will be not to define the capabilities at a very high level which would require the passing of many parameters between the client and the remote computer in order to update the status of that capability or to implement that capability.

Equally it will typically not be desirable to define the capabilities at too low a level where the number of capabilities needed to be invoked and/or kept track of in order to provide meaningful functionality on the client device will be too large which, in turn, will also contribute to an unnecessarily large amount of traffic passing between the client device and the remote computer.

Fourth Preferred Embodiment

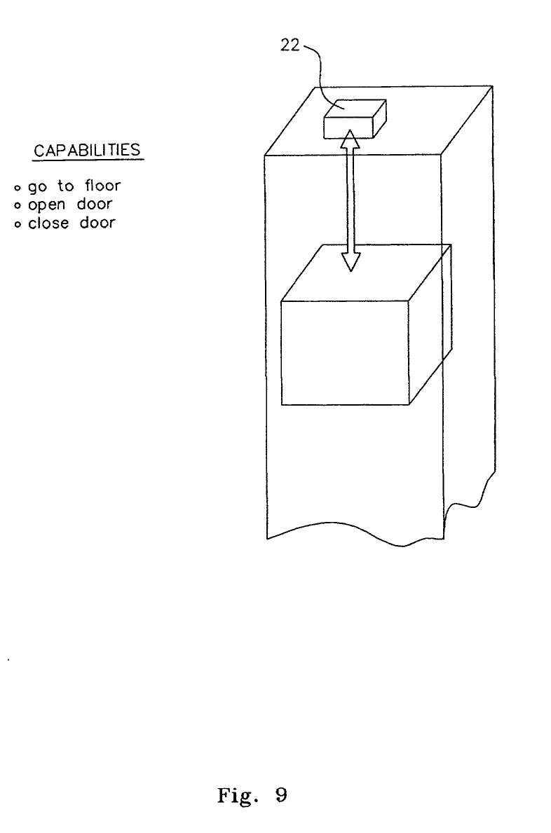

With reference to FIG. 9 an example is illustrated wherein the client device is a lift controller 22 and its capabilities are broken down into the following members:

1. Go to floor number

2. Open door

3. Close door

Fifth Preferred Embodiment

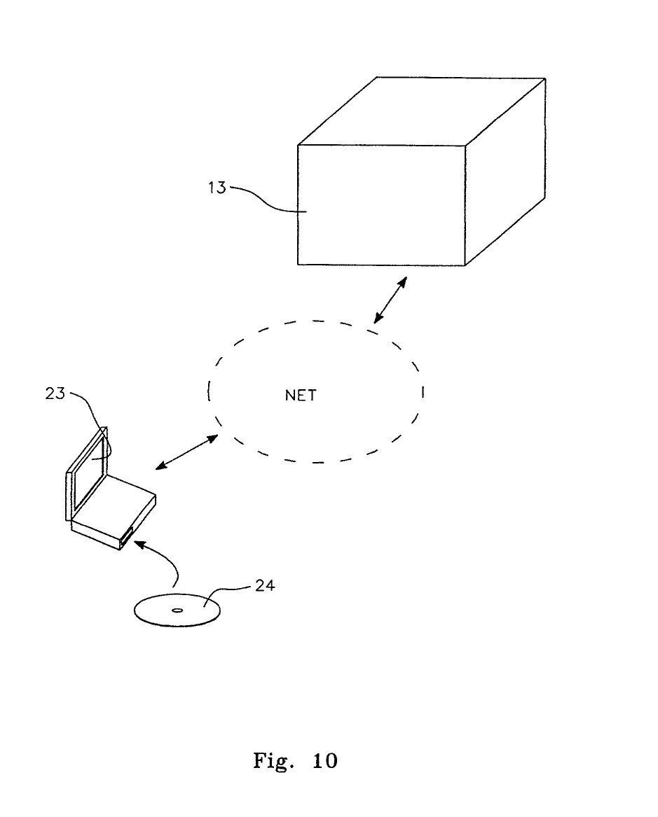

With reference to FIG. 10 there is illustrated a particular implementation of the arrangement of FIG. 6 and wherein the client is a laptop computer 23 which is loaded with the capability set definitions by means of a CD-ROM 24 having thereon the necessary definitions.

In an alternative form the definitions can be downloaded via the internet from a host site.

### INDUSTRIAL APPLICATIONS

The system according to various embodiments of the invention can be applied on almost any device which has a computing capability and the ability to communicate with other computing devices, whether on a one to one basis or as part of a much wider network of computing devices. The system can be utilised to enhance the capabilities of personal computing devices such as PDA's, PC's, hand held computers and the like. It can also be used to enhance the capability of computer enabled industrial devices including controllers of various kinds such as lift controllers, programmable logic controllers and the like.

The above describes only some embodiments of the present invention and modifications, obvious to those skilled in the art, can be made thereto without departing from the scope and spirit of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A distributed system for computer interaction; said system including
a device having computing means therein and
a remote computer located or locatable remotely from said device,
said device arranged to execute a client application which makes reference to a client capability set definition library located on said device;
said remote computer arranged to execute a control application which makes reference to a corresponding capability set definition library located on said remote computer.

2. The system of claim 1 wherein said system operates sequentially in the following steps:
(d) said client application on said device initiates communication with said control application on said remote computer for the purpose of establishing a communications session between said device and said remote computer;
(e) said client application and said control application agree on mutual use of said capability set definition library;
(f) said control application and said client application maintaining communication during said communication session whereby predetermined aspects of operation of said device are determined by said control application with reference to said capability set definition library.

3. A distributed client/server system for at least
a first device and
a first remote computer
said first device arranged to execute a client application which makes reference to an at least first client capability set driver;
said at least first remote computer arranged to execute a control application which makes reference to an at least first capability set definition library;
said system operating sequentially in the following steps:
(d) said client application on said device initiates communication with said control application on said remote computer for the purpose of establishing a communications session;
(e) said client application and said control application agree on a capability set definition library and a corresponding client capability set driver for use during said communication session;
(f) said control application and said client application maintaining communication during said communication session whereby predetermined aspects of operation of said device are determined by said control application with reference to said selected capability set definition library and said corresponding selected client capability set driver.

4. The system of claim 2 wherein said capability set definition library contains a set of definitions of predetermined, selected capabilities of said device.

5. The system of claim 4 wherein said predetermined capabilities are primitive functions of the device.

6. The system of claim 4 wherein said capabilities are selected in order to minimise traffic during said communications session.

7. The system of claim 2 wherein said communications session includes the communicating of update information pertinent to the status of individual ones of said capabilities invoked with the aid of said capability set definition library.

8. The system of claim 7 wherein said communications session occurs over a network link.

9. A distributed system for computer interaction; said system including
a device having computing means therein and
a remote computer located or locatable remotely from said device,
communication means whereby bi-directional communication is established between said device and said remote computer;
said device arranged to execute a client application;
said remote computer arranged to execute a control application.

10. The system of claim 9 wherein said device makes reference to a client capability set definition library located on said device.

10. The system of claim 10 wherein said control application makes reference to said capability set definition library.

11. The system of claim 10 wherein said capability set definition library resides on both said device and said remote computer.

12. The system of claim 9 wherein said system operates sequentially in the following steps:
(d) said client application on said device initiates communication with said control application on said remote computer for the purpose of establishing a communications session between said device and said remote computer;
(e) said client application and said control application agree on mutual use of said capability set definition library;
(f) said control application and said client application maintaining communication during said communication session whereby predetermined aspects of operation of said device are determined by said control application with reference to said capability set definition library.

13. The system of claim 13 wherein said capability set definition library contains a set of definitions of predetermined, selected capabilities of said device.

14. The system of claim 14 wherein said predetermined capabilities are primitive functions of the device.

15. The system of claim 14 wherein said capabilities are selected in order to minimise traffic during said communication session.

16. The system of claim 14 wherein said communication session includes the communicating of update information pertinent to the status of individual ones of the capabilities invoked with the aid of said capability set definition library.

17. In a distributed system for computer interaction; said system including
a device having computing means therein and
a remote computer located or locatable remotely from said device,
said device arranged to execute a client application;
said remote computer arranged to execute a control application; a method of operating said system according to the following:
(e) making available a capability set definition library on both said device and said remote computer;
(f) said client application on said device initiates communication with said control application on said remote computer for the purpose of establishing a communications session between said device and said remote computer;
(g) said client application and said control application agree on mutual use of said capability set definition library;
(h) said control application and said client application maintaining communication during said communication session whereby predetermined aspects of operation of said device are determined by said control application with reference to said capability set definition library.

18. The system of claim 9 wherein said remote computer builds a model of the state of said client application so as to interact with said device by interacting with said model.

19. The system of claim 19 wherein the said model is continuously updated so as to reflect current status of said client application on said device.

20. The system of claim 20 wherein said device is arranged to execute said client application with reference to a client capability set definition library located on said device and said remote computer is arranged to execute said control application by making reference to a corresponding capability set definition library located on said remote computer.

21. The system of claim 21 wherein said capability set definition library comprises a plurality of capability definitions, each of said definitions determined with reference to the desired functionality of said device.

22. The system of claim 22 wherein each of said capability definitions comprises a primitive function of said device.

23. The system of claim 22 wherein each of said capability definitions comprises a combination of primitive functions of said device.

24. A distributed client/server system for at least
a first device and
a first remote computer;
communication means whereby bi-directional communication is established between said device and said remote computer;
said first device arranged to execute a client application which makes reference to an at least first client capability set driver;
said at least first remote computer arranged to execute a control application which makes reference to an at least first capability set definition library;
said system operating sequentially in the following steps:
(d) said client application on said device initiates communication with said control application on said remote computer for the purpose of establishing a communications session;
(e) said client application and said control application agree on a capability set definition library and a corresponding client capability set driver for use during said communication session;
(f) said control application and said client application maintaining communication during said communication session whereby predetermined aspects of operation of said device are determined by said control application with reference to said selected capability set definition library and said corresponding selected client capability set driver;
said system arranged to communicate codes over said communication means which make reference to capability definitions in said capability set definition library thereby to control the volume of traffic on said communication means.
